(19) United States
(12) Patent Application Publication
(10) Pub. No.: US 2014/0032731 A1
(43) Pub. Date: Jan. 30, 2014

(54) Recursive, All-to-All Network Topologies

(71) Applicants: Iulin Lih, San Jose, CA (US); Chenghong He, Shenzhen (CN); Hongbo Shi, Xian (CN); Naxin Zhang, Singapore (SG)

(72) Inventors: Iulin Lih, San Jose, CA (US); Chenghong He, Shenzhen (CN); Hongbo Shi, Xian (CN); Naxin Zhang, Singapore (SG)

(73) Assignee: FUTUREWEI TECHNOLOGIES, INC., Plano, TX (US)

(21) Appl. No.: 13/952,208

(22) Filed: Jul. 26, 2013

Related U.S. Application Data
(60) Provisional application No. 61/676,587, filed on Jul. 27, 2012.

(51) Int. Cl. H04L 12/24

(52) U.S. Cl. CPC H04L 41/14
USPC 709/223

(57) ABSTRACT

An apparatus comprises an interconnection network comprising N^{K} nodes, wherein N is an integer of two or greater and represents a degree of the network, wherein each node comprises N ports, wherein K is an integer of one or greater and represents a recursion level of the network, and wherein N ports are left available for recursion, and N^{K-1} clusters of nodes, wherein each cluster comprises N nodes, wherein each node within each cluster is directly connected to each remaining node in the cluster, and wherein each cluster is directly connected to at least one remaining cluster.

### CROSS-REFERENCE TO RELATED APPLICATIONS

This application claims priority to U.S. Provisional Application No. 61/676,587 filed Jul. 27, 2012 by Yolin Lih, et al., and titled “Recursive All-to-All Network Topologies,” which is incorporated by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

An interconnection network may refer to any system that enables fast data communication among its components, or nodes. An interconnection network may be any switch, router, processor-memory, input/output (I/O), system on a chip (SoC), multiple-chip, or other network. An SoC may refer to a system that integrates all the functionality of a computer or other complex electronic data system onto a single integrated circuit, or chip.

Data in an interconnection network may be exchanged from one node to another node in what is called a transaction. A transaction may comprise phases such as a request for data, a transmission of the data, and an acknowledgment of receipt of the data. The data may be exchanged in the form of a packet, which may typically comprise a header containing control information and a payload containing the data that is the purpose of the transmission.

Network topology may refer to the arrangement of the nodes in an interconnection or other network. Topology design may affect network performance, cost, power use, and flexibility. For example, a first type of topology may provide for faster transaction completion compared to a second type of topology. The second type of topology may, however, require less expensive hardware compared to the first type of topology. Consequently, topology design involves weighing many factors and is an important aspect of network implementation.

### SUMMARY

In one embodiment, the disclosure includes an interconnection network comprising N^{K} nodes, wherein N is an integer of two or greater and represents a degree of the network, wherein each node comprises N ports, wherein K is an integer of one or greater and represents a recursion level of the network, and wherein N ports are left available for recursion, and N^{K-1} clusters of nodes, wherein each cluster comprises N nodes, wherein each node within each cluster is directly connected to each remaining node in the cluster, and wherein each cluster is directly connected to at least one remaining cluster.

In another embodiment, the disclosure includes an interconnection network comprising a plurality of inter-cluster links, a plurality of intra-cluster links, and a plurality of clusters, wherein each cluster is directly connected via an inter-cluster link to at least one other cluster, wherein each cluster comprises N nodes where N is an integer of two or greater, wherein each node comprises N ports, wherein each node is directly connected via an intra-cluster link to each remaining node in a same cluster, and wherein N inter-cluster links are left available for recursion.

In yet another embodiment, the disclosure includes an interconnection network comprising a plurality of inter-cluster links, a plurality of intra-cluster links, and a plurality of clusters, wherein each cluster is directly connected via an inter-cluster link to at least one remaining cluster, wherein each cluster within a first set of clusters comprises N nodes where N is an integer of two or greater, wherein each node within the first set of clusters comprises N ports, wherein each node in the first set of clusters is directly connected via an intra-cluster link to each remaining node in a same cluster, wherein each remaining cluster is part of a second set of clusters, wherein at least one non-uniform node within the second set of clusters comprises M ports where M is an integer of two or greater and is not equal to N, wherein each node in the second set of clusters is directly connected via an intra-cluster link to at least one remaining node in a same cluster, and wherein at least one inter-cluster link is left available for recursion.

In yet another embodiment, the disclosure includes an interconnection network comprising a plurality of inter-cluster links, a plurality of intra-cluster links, and a plurality of clusters, wherein each cluster is directly connected via an inter-cluster link to at least one remaining cluster, wherein each cluster within a first set of clusters comprises N nodes where N is an integer of two or greater, wherein each node within the first set of clusters comprises N ports, wherein each node in the first set of clusters is directly connected via an intra-cluster link to each remaining node in a same cluster, wherein each remaining cluster is part of a second set of clusters, wherein at least one non-uniform cluster in the second set of clusters comprises L nodes where L is an integer of two or greater and is not equal to N, wherein each node in the second set of clusters is directly connected via an intra-cluster link to at least one remaining node in a same cluster, and wherein at least one inter-cluster link is left available for recursion.

In yet another embodiment, the disclosure includes a method comprising providing a network, designing a network topology for the network, wherein the topology comprises N^{K} nodes and N^{K-1} clusters of nodes, wherein N is an integer of two or greater and represents a degree of the network, wherein each node comprises N ports, wherein K is an integer of one or greater and represents a recursion level of the network, wherein N ports are left available for recursion, wherein each cluster comprises N nodes, wherein each node within each cluster is directly connected to each remaining node in the cluster, and wherein each cluster is directly connected to at least one remaining cluster, and deploying the network.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a network with a ring topology.

FIG. 2 is a schematic diagram of a network with a torus topology.

FIG. 3 is a schematic diagram of a third-degree network according to an embodiment of the disclosure.

FIG. 4 is a schematic diagram of another third-degree network according to an embodiment of the disclosure.

FIG. 5 is a schematic diagram of yet another third-degree network according to an embodiment of the disclosure.

FIG. 6 is a schematic diagram of yet another third-degree network according to an embodiment of the disclosure.

FIG. 7 is a schematic diagram of a fourth-degree network according to an embodiment of the disclosure.

FIG. 8 is a schematic diagram of another fourth-degree network according to an embodiment of the disclosure.

FIG. 9 is a schematic diagram of yet another fourth-degree network according to an embodiment of the disclosure.

FIG. 10 is a schematic diagram of yet another fourth-degree network according to an embodiment of the disclosure.

FIG. 11 is a schematic diagram of yet another fourth-degree network according to an embodiment of the disclosure.

FIG. 12 is a schematic diagram of a fifth-degree network according to an embodiment of the disclosure.

FIG. 13 is a schematic diagram of another fifth-degree network according to an embodiment of the disclosure.

FIG. 14 is a schematic diagram of yet another fifth-degree network according to an embodiment of the disclosure.

FIG. 15 is a schematic diagram of a sixth-degree network according to an embodiment of the disclosure.

FIG. 16 is a schematic diagram of another sixth-degree network according to an embodiment of the disclosure.

FIG. 17 is a schematic diagram of yet another sixth-degree network according to an embodiment of the disclosure.

FIG. 18 is a schematic diagram of a non-uniform network according to an embodiment of the disclosure.

FIG. 19 is a flowchart illustrating a method according to an embodiment of the disclosure.

FIG. 20 is a schematic diagram of a network device according to an embodiment of the disclosure.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

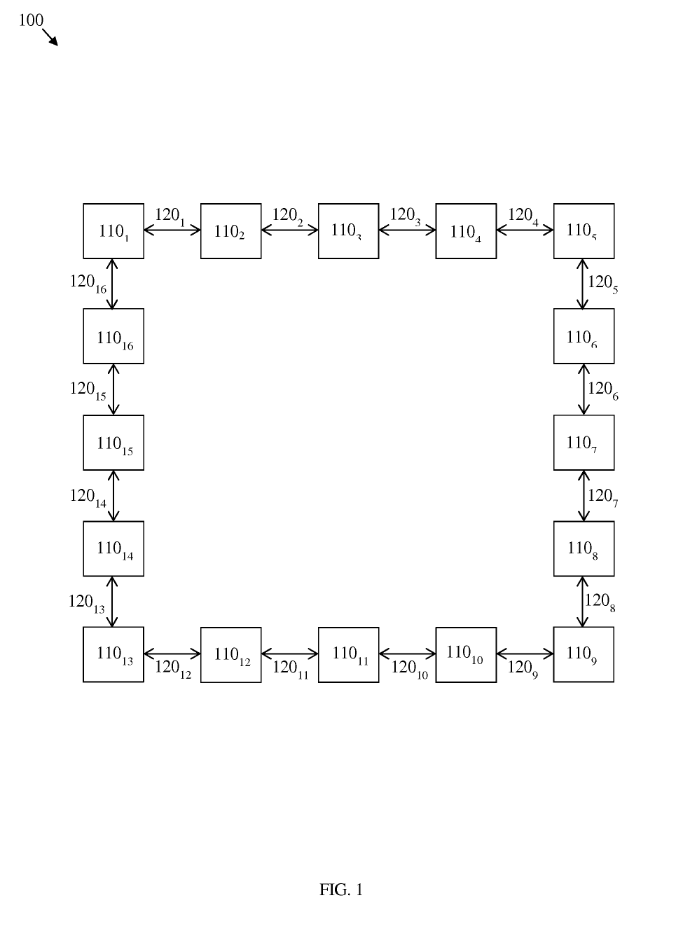

FIG. 1 is a schematic diagram of a network 100 with a ring topology. The network 100 may also be referred to as a ring network. The network 100 may comprise 16 nodes 110 and 16 links 120. The term “link” may be used interchangeably with the term “connection” and may mean any physical or logical connection for transferring data. A link may be between two nodes in a network and may allow data to be transferred between those two nodes. A number of degrees may indicate the number of ports for each node. In the network 100, each node 110 may comprise two ports, and thus the network 100 may be referred to as a second-degree network. It can be seen that each node 110 comprises two ports because each node has two links 120 associated with it. In other words, each link 120 may extend from a port in the respective node 110. Ports may be associated with hardware cost. Ring networks may therefore be advantageous in that they may provide for relatively fewer ports, and thus less cost, compared to networks with other topologies. In addition, ring networks may comprise any number of nodes and may therefore be any length.

Ring networks, however, have some disadvantages. As shown, each node 110 may have a link 120 to only two other nodes 110. For example, the node 110₂ may have the link 120₁ to the node 110₁ and the link 120₂ to the node 110₃. Sometimes, data transactions may occur between non-contiguous nodes. In that case, the data packets may traverse through multiple intermediary nodes and links. Each such link may be referred to as a hop. For example, if there is a transaction between the node 110₁ and the node 110₅, then the packets may need to traverse through the nodes 110₂, 110₃, 110₄ and the links 120₁, 120₂, 120₃, 120₄. Accordingly, the transaction may require four hops. In the network 100, the longest hop count, for example, the hop count from the node 110₁ to the node 110₉, may be eight. In general, ring networks comprising N nodes may have a longest hop count of about N/2 and an average hop count of about N/4. Ring networks may therefore be disadvantageous in that they may require relatively longer hop counts for some transactions compared to networks with other topologies. The longer hop counts may cause increased latency, which may refer to the time delay in completing a transaction, because the packets must travel farther. In addition, ring networks may experience increased packet contention and other routing issues. Packet contention may occur when packets from different transactions attempt to traverse the same link at the same time, causing a packet traffic bottleneck at that link. The increased packet contention may occur because of the lack of direct links between nodes so that packets must traverse the same nodes and links even if they have different destination nodes. For example, if there are two transactions, a first transaction between the node 110₁ and the node 110₅ and a second transaction between the node 110₁ and the node 110₉, then packets for both transactions must traverse the nodes 110₂, 110₃, 110₄ and the links 120₁, 120₂, 120₃, 120₄ even though the two transactions have different destinations. Accordingly, if the node 110₁ is a relatively frequent source of packet generation, the nodes 110₂, 110₃, 110₄ may experience increased packet contention and other routing issues even if they are not typical destination nodes.

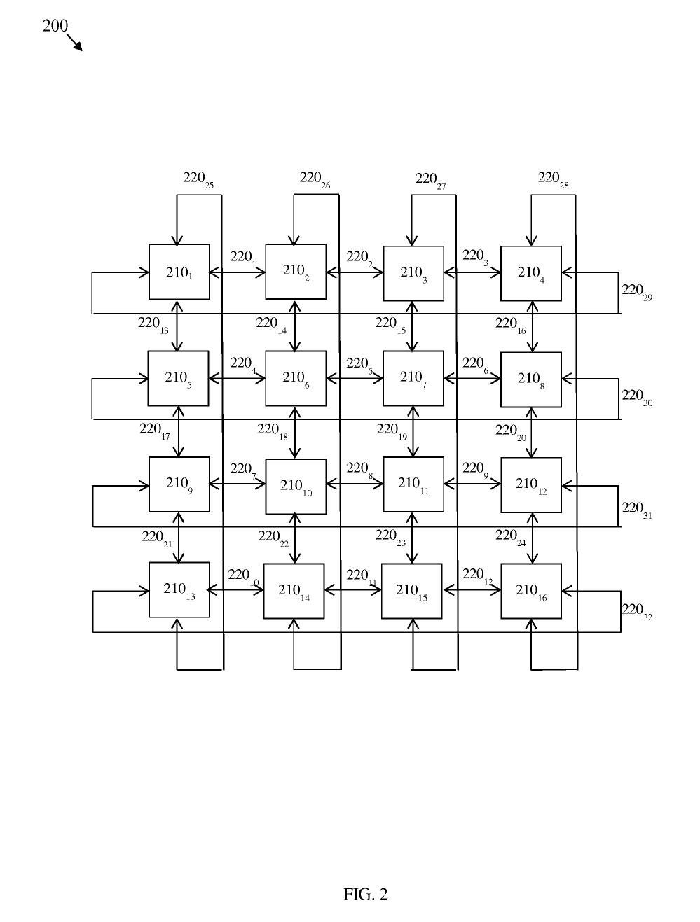

FIG. 2 is a schematic diagram of a network 200 with a torus topology. The network 200 may also be referred to as a torus network. The network 200 may comprise 16 nodes 210 and 32 links 220. Each node 210 may comprise four ports, and thus the network 200 may be referred to as a fourth-degree network. The network 200 may also be referred to as a four-by-four network because it comprises four rows and four columns of the nodes 210 and/or may be referred to as a two-dimensional network because it comprises the links 220₂₅-220₃₂, which may cross over the remaining links 220₁-220₂₄. In the network 200, the longest hop count, for example the count between the node 210₁ and the node 210₁₁, may be four. In general, two-dimensional, N×N torus networks may have a longest hop count of N and an average hop count of N/2.

Disclosed herein are systems and methods for improved network topologies. The disclosed techniques may provide recursive, all-to-all network topologies. Recursive may be used interchangeably with hierarchical and fractal and may mean that a topology may be included as a subset of a larger topology, the larger topology may be included as a subset of an even larger topology, and so on. All-to-all may mean that a direct path may exist from any one node to any other node without any intervening nodes. Generally, when compared to ring, torus, and other topologies, the topologies designed using the disclosed techniques may exhibit: a reduced maximum hop count; a reduced average hop count; improved performance, particularly for networks with spatial locality, meaning networks with transactions occurring in relatively close proximity; and improved flexibility, all while maintaining costs. Specifically, the disclosed topologies may exhibit reduced latency because of a reduced hop count. With reduced latency, less bandwidth may be required to perform the same amount of transactions. With reduced bandwidth, cost may be reduced because less hardware is required. With less traffic, less power may be used because less processing is required. Finally, the disclosed topologies may exhibit improved flexibility by supporting relatively larger networks with a fixed number of ports per node. The disclosed topologies may be applied to any suitable interconnection networks.

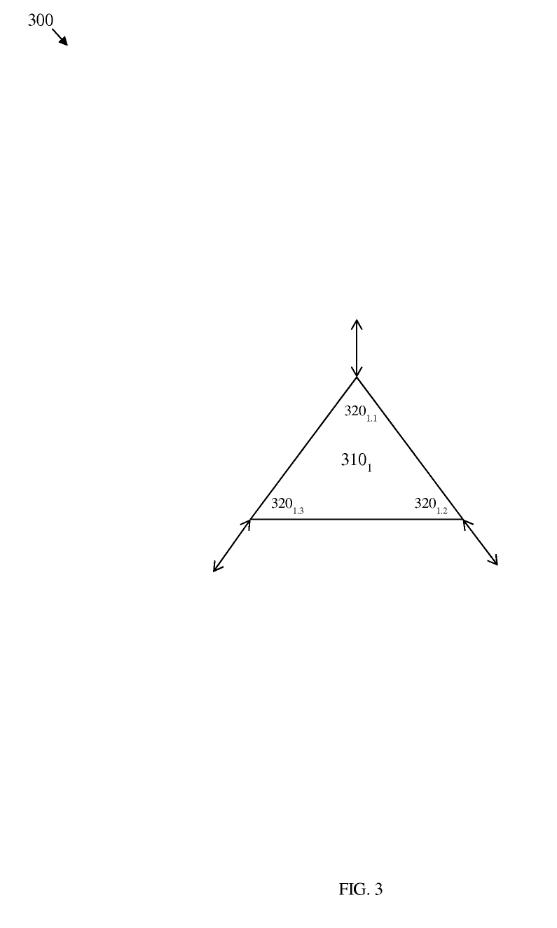

FIG. 3 is a schematic diagram of a third-degree network 300 according to an embodiment of the disclosure. The network 300 may comprise a node 310₁, which may comprise three ports 320_{1.1}-320_{1.3}. With the disclosed technique, when N represents the degree of a network, or the number of ports per node, and there are N^{K} nodes in the network, K may represent the recursion level of the network. In this case, the network 300 may comprise 3⁰ nodes and may therefore be referred to as a zero-level network. Because the network 300 may comprise only one node, the node 310₁, the network 300 may have a hop count of zero.

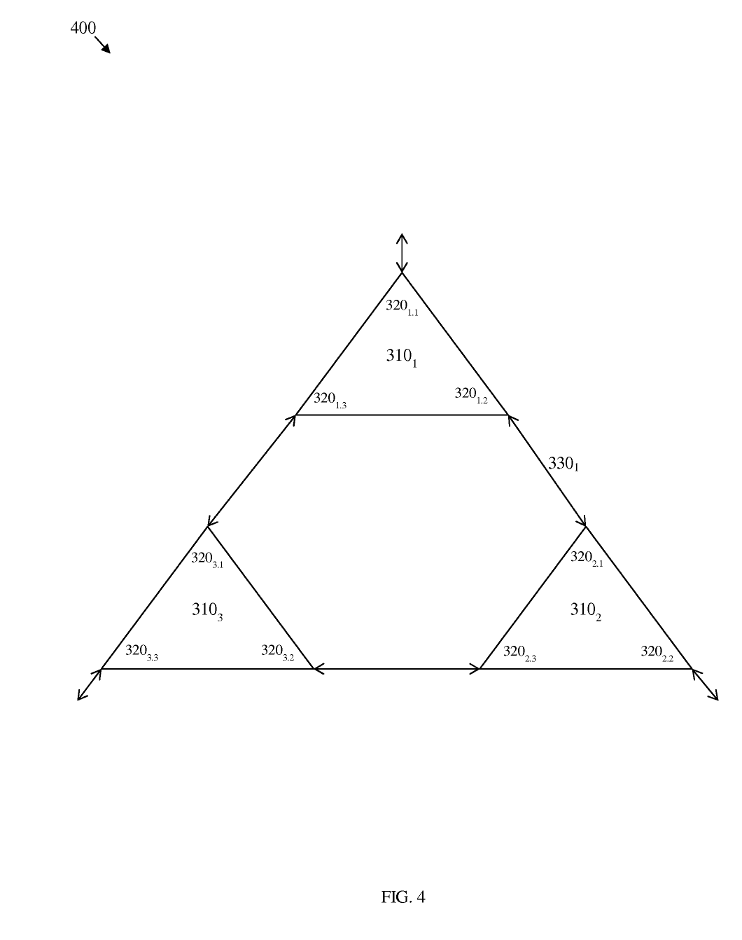

FIG. 4 is a schematic diagram of another third-degree network 400 according to an embodiment of the disclosure. The network 400 may comprise three nodes 310₁-310₃, each with three ports 320_{1.1}-320_{1.3}, 320_{2.1}-320_{2.3}, 320_{3.1}-320_{3.3}. The network 400 may comprise 3¹ nodes and may therefore be referred to as a first-level network. In the network 400, the longest hop count, for example, the hop count from the node 310₁ to the node 310₂, may be one, as shown by the link 330₁.

The network 400 may be constructed in the following manner: first, the nodes may be labeled in a sequential, clockwise order. The top node may be labeled node 310₁, the second node moving clockwise may be labeled node 310₂, and the third node may be labeled node 310₃. Second, the ports of each node may be labeled in a sequential, clockwise order. For example, the top port of the first node 310₁ may be labeled port 320_{1.1}, the second port moving clockwise may be labeled port 320_{1.2}, and the third port moving clockwise may be labeled port 320_{1.3}. The ports of the nodes 310₂, 310₃ may be labeled in a similar manner. Third, the ports may be connected in an algorithmic manner. For the node 310₁, the port 320_{1.1} may be left available for recursion or other suitable design purposes, the port 320_{1.2} may connect to the port 320_{2.1}, and the port 320_{1.3} may connect to the port 320_{3.1}. For the node 310₂, the port 320_{2.2} may be left available for recursion or other suitable design purposes, and the port 320_{2.3} may connect to the port 320_{3.2}. For the node 310₃, the port 320_{3.3} may be left available for recursion or other suitable design purposes. With the disclosed technique, in general, the ith port of the jth node in a network may connect to the jth port of the ith node, where i and j are sets of integers from one to N and where N represents the degree of the network. When i and j are the same, the port may be left available for recursion or other suitable design purposes. Similarly, the jth node of the kth cluster may connect to the kth node of the jth cluster, where k is the set of integers from one to N^{K-1}. When i, j, and k are the same, the ith port of the jth node may be left available for recursion or other suitable design purposes. When a port is said to be left available for recursion or other suitable design purposes, it may be understood that the port may comprise a link for such purposes as well. The link may be suitable for linking to any node in the network. The disclosed technique may be applied to the networks described below, as well as networks of other degrees and levels.

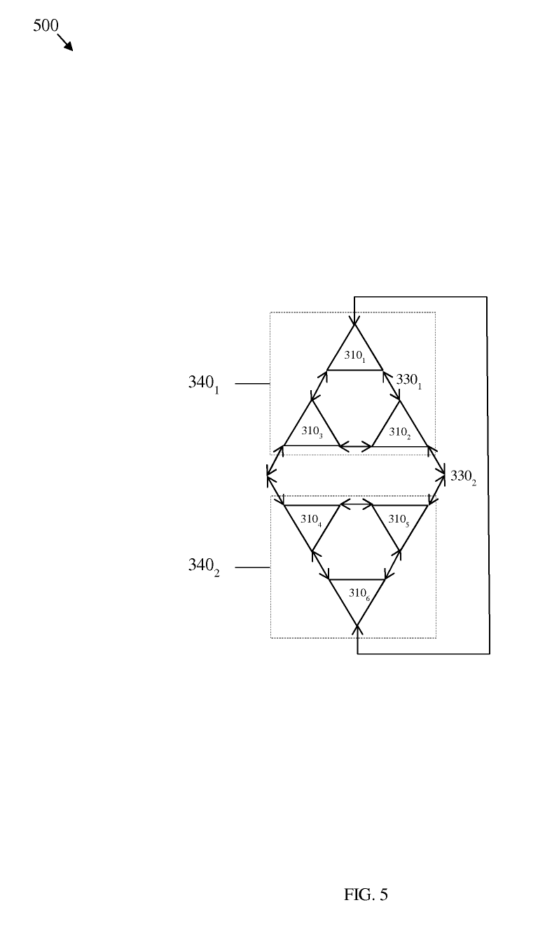

FIG. 5 is a schematic diagram of yet another third-degree network 500 according to an embodiment of the disclosure. The network 500 may comprise six nodes 310₁-310₆ and two clusters 340₁, 340₂ of nodes. Each cluster 340₁, 340₂ may comprise 3¹ nodes and may therefore be referred to as a first-level network so that the network 500 may be said to comprise two first-level sub-networks. In the network 500, the longest hop count, for example, the hop count from the node 310₁ to the node 310₅, may be two, as shown by the links 330₁, 330₂.

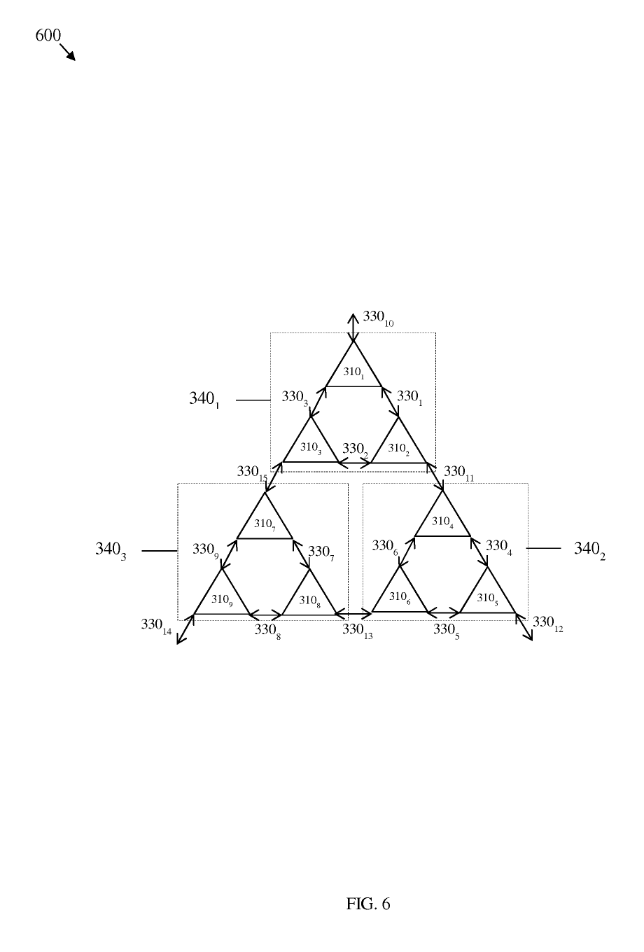

FIG. 6 is a schematic diagram of yet another third-degree network 600 according to an embodiment of the disclosure. The network 600 may comprise nine nodes 310₁-310₉, three clusters 340₁-340₃ of nodes, and 12 links 330₁-330₁₂. The network 600 may comprise 3² nodes and may therefore be referred to as a second-level network. The network 600 may be said to be all to all because, for each node within a cluster, a direct path may exist from that node to any other node in the cluster. For example, the node 310₁ in the cluster 340₁ may have a direct path to the nodes 310₂, 310₃ in the same cluster. The network 600 may be said to be recursive because each cluster 340₁, 340₂, 340₃ may comprise a topology that may be included as a subset of a larger topology, namely the network 600. Similarly, other disclosed networks may be said to be recursive and all to all. In the network 600, the longest hop count, for example, the hop count from the node 310₁ to the node 310₅, may also be three, as shown by the links 330₁, 330₁₁, 330₄. The links 330₁-330₉ may be referred to as intra-cluster links because they may link each node 310₁-310₉ to each remaining node 310₁-310₉ within a cluster 340₁-340₃. The links 330₁₀-330₁₅ may be referred to as inter-cluster links because the links 330₁₁, 330₁₃, 330₁₅ may link the clusters 340₁-340₃ together and the links 330₁₀, 330₁₂, 330₁₄ may provide links to additional clusters for recursion.

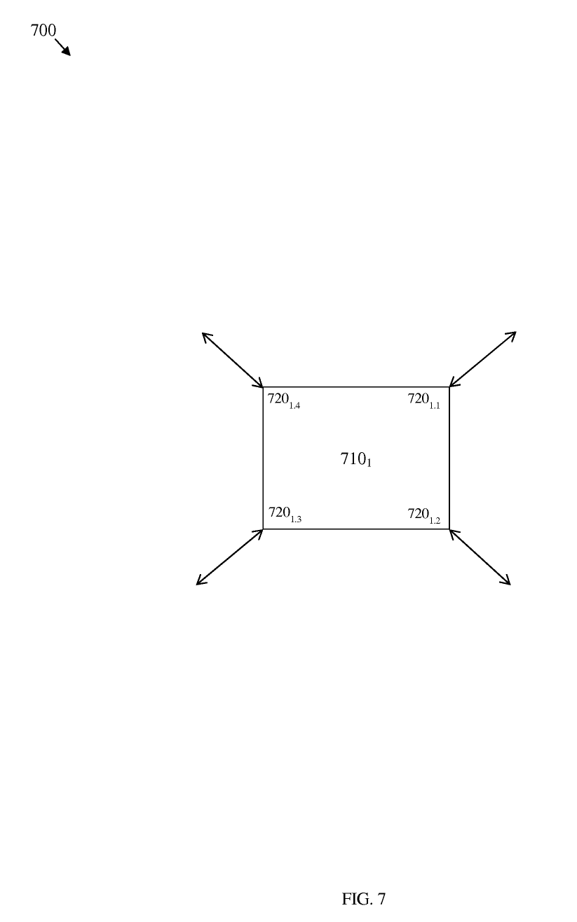

FIG. 7 is a schematic diagram of a fourth-degree network 700 according to an embodiment of the disclosure. The network 700 may comprise a node 710₁, which may comprise four ports 720_{1.1}-720_{1.4}. Because the network 700 may comprise only one node, the node 710₁, the network 700 may have a hop count of zero.

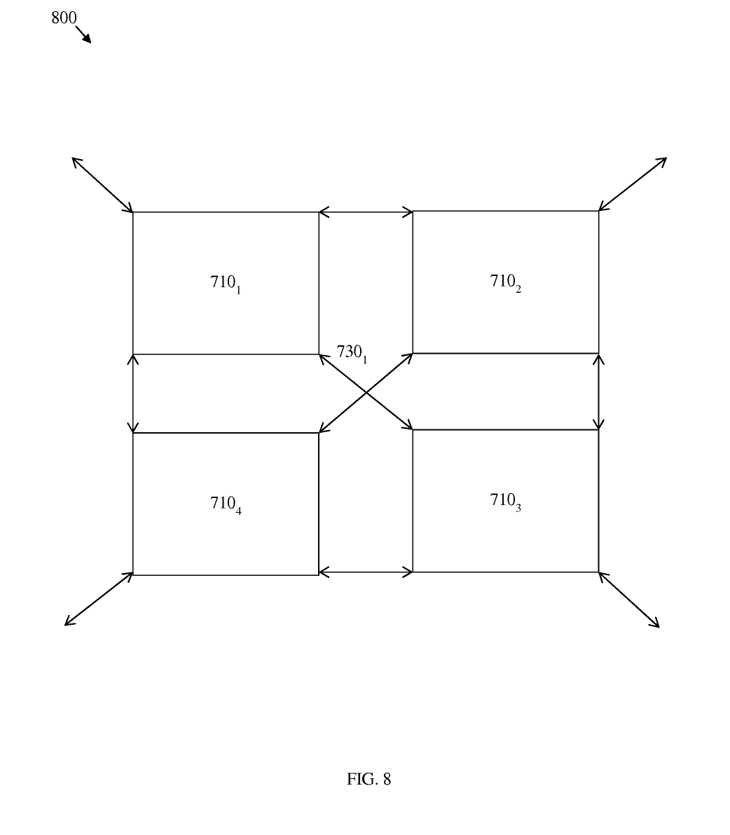

FIG. 8 is a schematic diagram of another fourth-degree network 800 according to an embodiment of the disclosure. The network 800 may comprise four nodes 710₁-710₄ and may be referred to as a first-level network. In the network 800, the longest hop count, for example, the hop count from the node 710₁ to the node 710₃, may be one, as shown by the link 730₁.

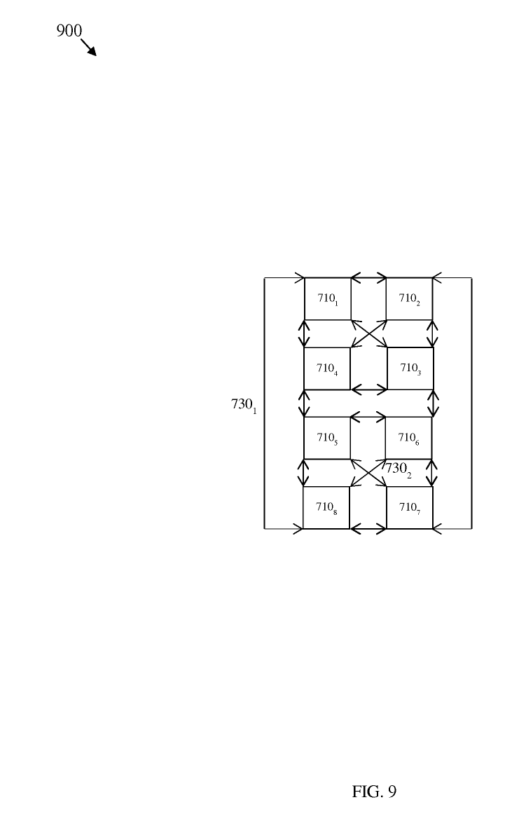

FIG. 9 is a schematic diagram of yet another fourth-degree network 900 according to an embodiment of the disclosure. The network 900 may comprise eight nodes 710₁-710₈ and may be said to comprise two first-level sub-networks. In the network 900, the longest hop count, for example, the hop count from the node 710₁ to the node 710₆, may be two, as shown by the links 730₁-730₂.

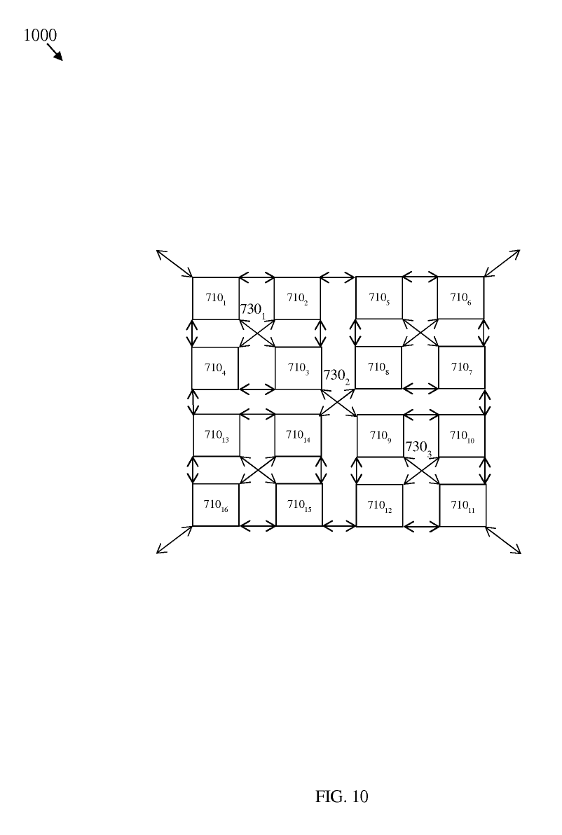

FIG. 10 is a schematic diagram of yet another fourth-degree network 1000 according to an embodiment of the disclosure. The network 1000 may comprise 16 nodes 710₁-710₁₆ and may be referred to as a second-level network. In the network 1000, the longest hop count, for example, the hop count from the node 710₁ to the node 710₁₁, may be three, as shown by the links 730₁-730₃.

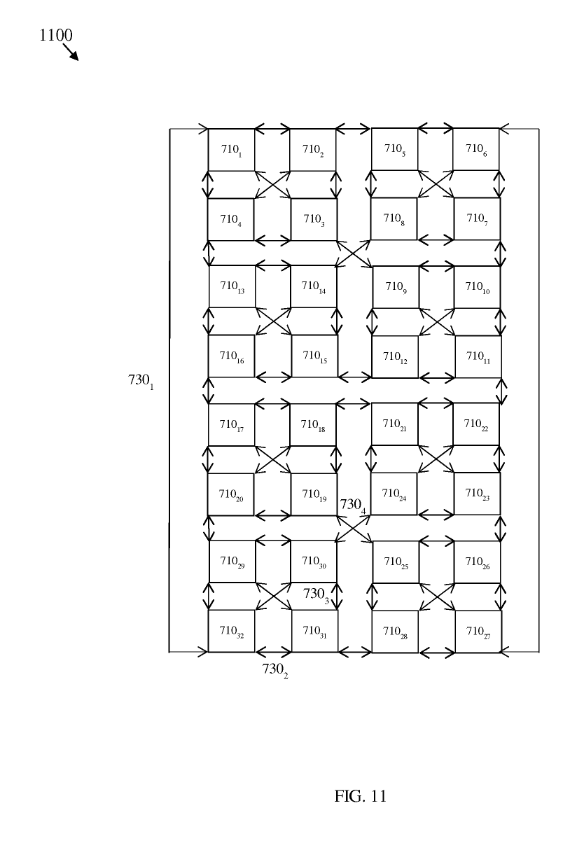

FIG. 11 is a schematic diagram of yet another fourth-degree network 1100 according to an embodiment of the disclosure. The network 1100 may comprise 32 nodes 710₁-710₃₂ and may be said to comprise two second-level networks. In the network 1100, the longest hop count, for example, the hop count from the node 710₁ to the node 710₂₄, may be four, as shown by the links 730₁-730₄.

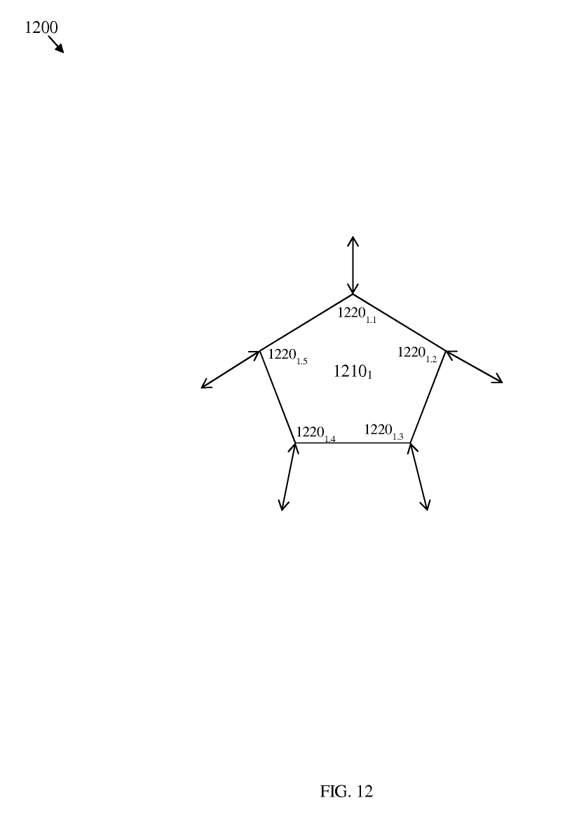

FIG. 12 is a schematic diagram of a fifth-degree network 1200 according to an embodiment of the disclosure. The network 1200 may comprise a node 1210₁, which may comprise five ports 1220_{1.1}-1220_{1.5}. Because the network 1200 may comprise only one node, the node 1210₁, the network 1200 may have a hop count of zero.

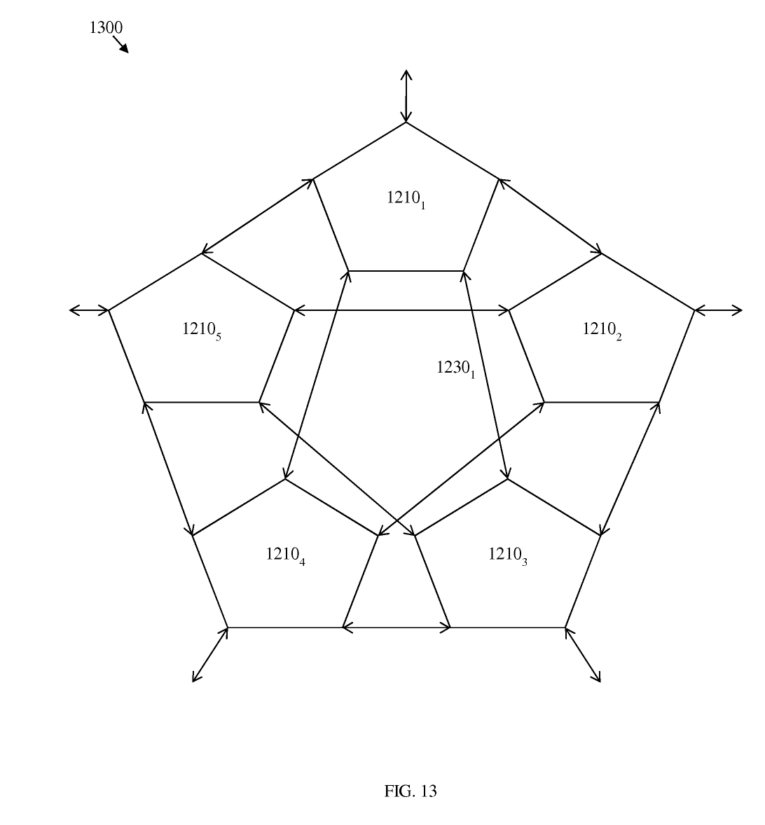

FIG. 13 is a schematic diagram of another fifth-degree network 1300 according to an embodiment of the disclosure. The network 1300 may comprise five nodes 1210₁-1210₅ and may therefore be referred to as a first-level network. In the network 1300, the longest hop count, for example, the hop count from the node 1210₁ to the node 1210₃, may be one, as shown by the link 1230₁.

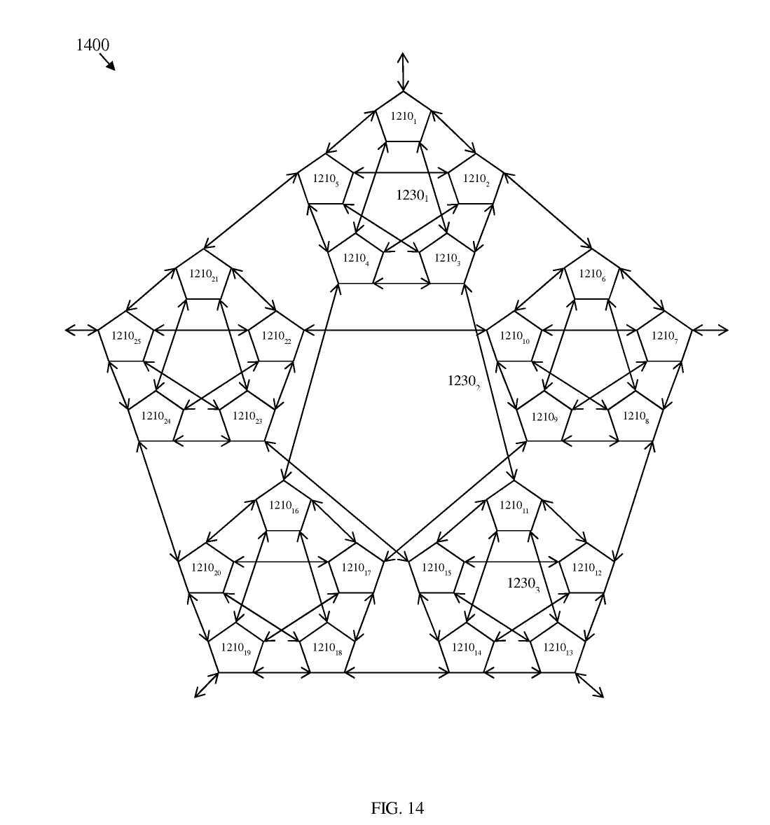

FIG. 14 is a schematic diagram of yet another fifth-degree network 1400 according to an embodiment of the disclosure. The network 1400 may comprise 25 nodes 1210₁-1210₂₅ and may therefore be referred to as a second-level network. In the network 1400, the longest hop count, for example, the hop count from the node 1210₁ to the node 1210₁₃, may be three, as shown by the links 1230₁-1230₃.

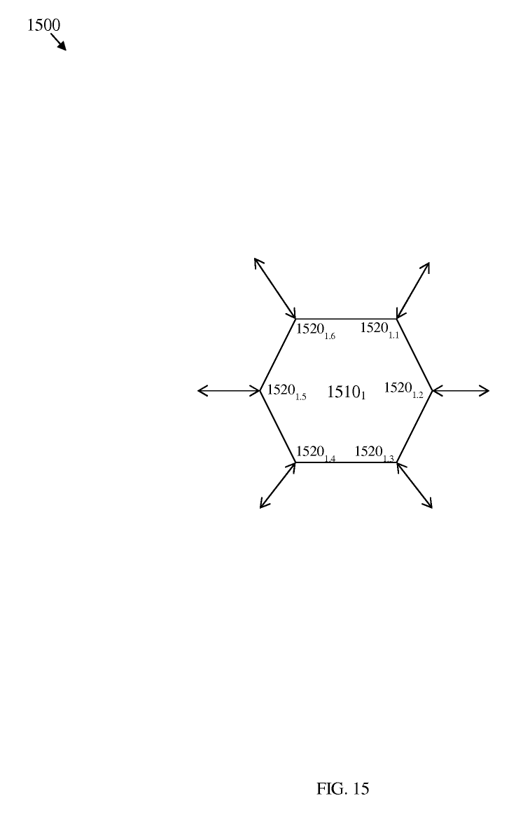

FIG. 15 is a schematic diagram of a sixth-degree network 1500 according to an embodiment of the disclosure. The network 1500 may comprise a node 1510₁, which may comprise six ports 1520_{1.1}-1520_{1.6}. Because the network 1500 may comprise only one node, the node 1510₁, the network 1500 may have a hop count of zero.

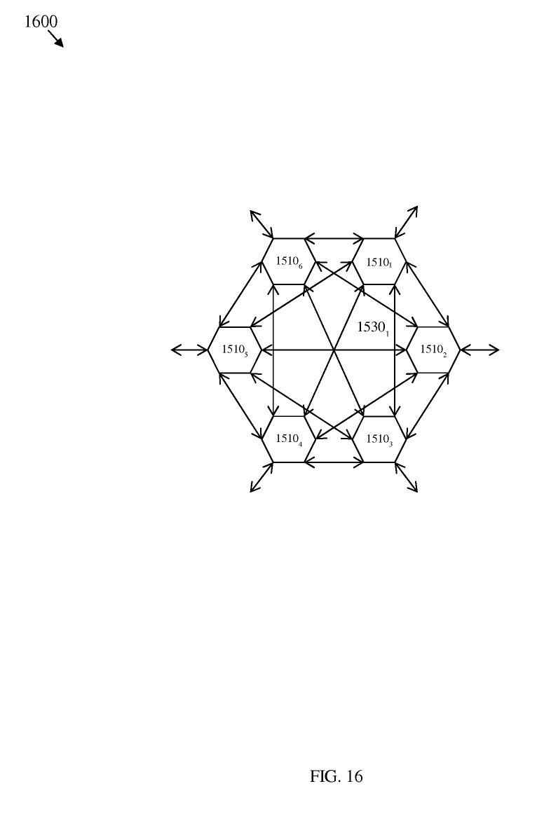

FIG. 16 is a schematic diagram of another sixth-degree network 1600 according to an embodiment of the disclosure. The network 1600 may comprise six nodes 1510₁-1510₆ and may therefore be referred to as a first-level network. In the network 1600, the longest hop count, for example, the hop count from the node 1510₁ to the node 1510₃, may be one, as shown by the link 1530₁.

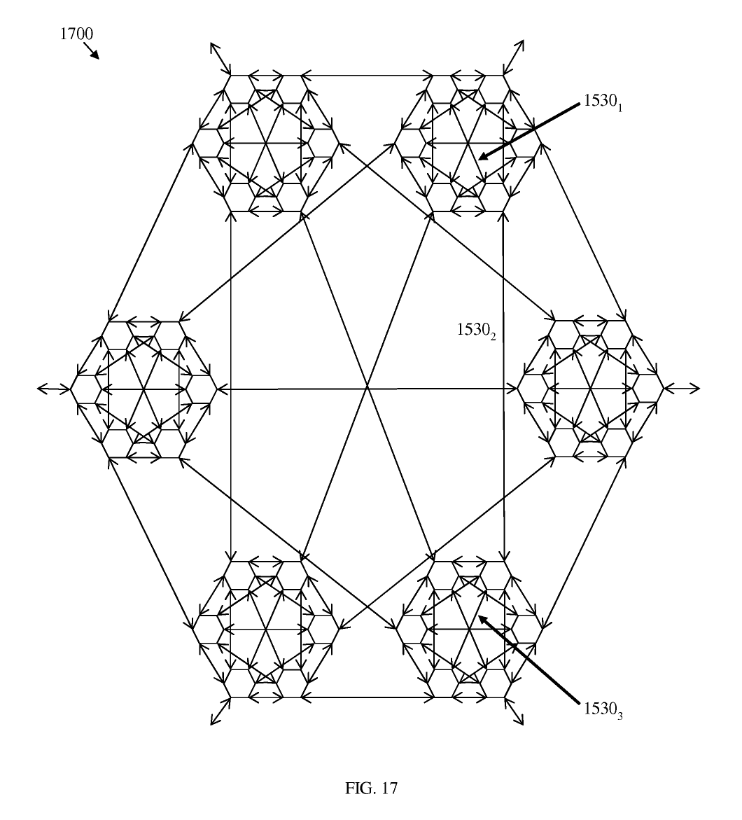

FIG. 17 is a schematic diagram of yet another sixth-degree network 1700 according to an embodiment of the disclosure. The network 1700 may comprise 36 nodes (not labeled) and may therefore be referred to as a second-level network. In the network 1700, the longest hop count may be three, as shown by the links 1530₁-1530₃.

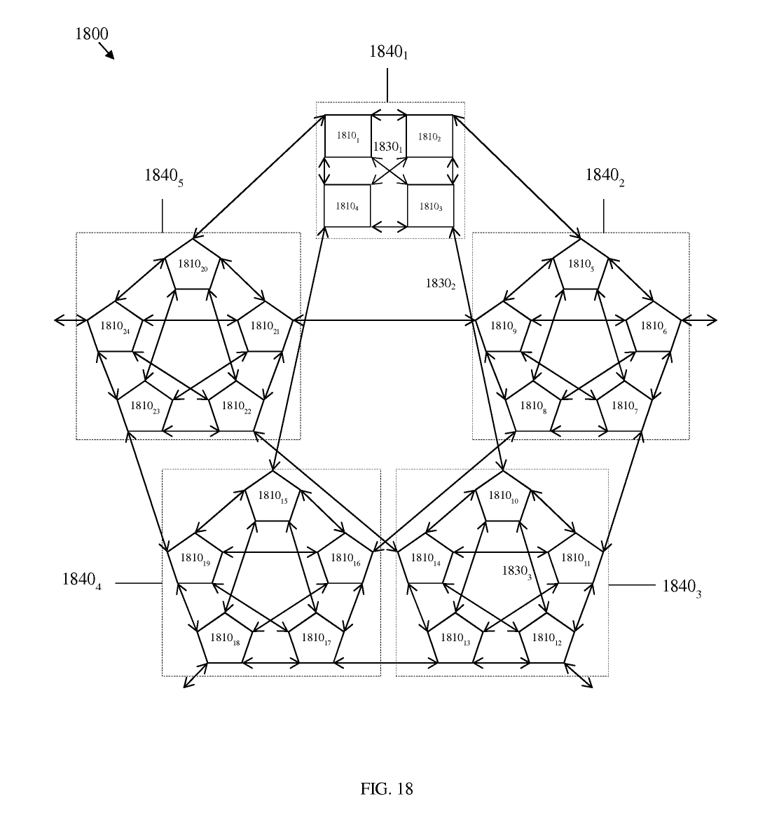

FIG. 18 is a schematic diagram of a non-uniform network 1800 according to an embodiment of the disclosure. The network 1800 may comprise 24 nodes 1810₁-1810₂₄ and five clusters 1840₁-1840₅ of nodes. Non-uniform may be used interchangeably with degenerated and may mean that a network comprises an uneven number of nodes per cluster or an uneven number of ports per node. As shown, the network 1800 is non-uniform because the uniform clusters 1840₂-1840₅ may comprise the nodes 1810₅-1810₂₄, each with five ports (not labeled), while the non-uniform cluster 1840₁ may comprise the nodes 1810₁-1810₄, each with four ports (not labeled). Each of the uniform clusters 1840₂-1840₅ may comprise an available port while the non-uniform cluster 1840₁ may not comprise an available port. In the network 1800, the longest hop count, for example, the hop count from the node 1810₁ to the node 1810₁₂, may be three, as shown by the links 1830₁-1830₃. The network 1800 may therefore maintain the maximum hop count of the network 1400 despite the non-uniform nature of the network 1800.

While the disclosed technique may provide for the non-uniform network 1800, the disclosed technique may provide for additional non-uniform networks as well. As a first example, such non-uniform networks may comprise any number of non-uniform clusters. For instance, the uniform cluster 1840₂ may also be non-uniform.

As a second example, such non-uniform networks may comprise non-uniform clusters with N nodes, but where at least one of the N nodes comprises M ports where M is an integer of two or greater and is not equal to N. That node may therefore be referred to as a non-uniform node. When that is the case, when M is less than N, each non-uniform cluster may comprise no inter-cluster links left available for recursion or other suitable design purposes. When N−M is greater than one, then at least one other node in the network 1800 may not be able to connect to the non-uniform node. When M is greater than N, each non-uniform cluster may comprise M−N additional inter-cluster links left available. For instance, the uniform cluster 1840₂ may comprise the five nodes 1810₅-1810₉, but the node 1810₆ may comprise four ports, so the uniform node 1810₆ may therefore become non-uniform and comprise no links left available.

As a third example, such non-uniform networks may comprise non-uniform clusters with L nodes where L is an integer of two or greater and is not equal to N. When that is the case, when L is less than N, each non-uniform cluster may comprise no inter-cluster links left available. When N−M is greater than one, then at least one other node in the network 1800 may not be able to connect to the non-uniform cluster. When L is greater than N, each non-uniform cluster with a non-uniform node may comprise L−N additional inter-cluster links left available. For instance, the uniform cluster 1840₂ may comprise an additional node, so the uniform cluster 1840₂ may become non-uniform and comprise L−N additional inter-cluster links left available.

As a fourth example, such non-uniform networks may comprise non-uniform clusters with L nodes where at least one of the L nodes comprises M ports. When that is the case, each non-uniform cluster may have varying numbers of links left available. For instance, the non-uniform cluster 1840₁ may comprise the four nodes 1810₁-1810₄, but the node 1810₁ may comprise five ports, so the non-uniform cluster 1840₁ may comprise an inter-cluster link left available.

As shown above, when using the disclosed technique and when N is the number of ports per node, K is the level of the network, and K is an integer greater than zero, each uniform network with N^{K} nodes in N^{K-1} clusters may comprise N available ports. Each such network may have a maximum hop count of 2^{K}−1 and an average hop count of 2^{K-1}. For example, the 16-node network 1000 may have a maximum hop count of 2²−1=3 and an average hop count of 2²⁻¹=2. If the network 1000 experiences relatively good spatial locality, the typical hop count may be one. In comparison, a 16-node, 4×4 torus network may have a maximum hop count of about four and an average hop count of about two. The disclosed techniques may therefore achieve an improved maximum, average, and typical hop count for a 16-node network. The disclosed techniques may achieve similar advantages for networks of other degrees and levels as well. Each uniform network with two sub-networks, where each sub-network comprises N^{K} nodes in N^{K-1} clusters, may comprise no available ports. Each such network may achieve an improved maximum, average, and typical hop count compared to other networks comprising the same number of nodes. Note that the maximum, average, and typical hop count of uniform networks designed using the disclosed techniques do not depend on the degree of such networks. Non-uniform networks designed using the disclosed techniques may have differing maximum, average, and typical hop counts, but those hop counts may be improved compared to other networks comprising the same number of nodes.

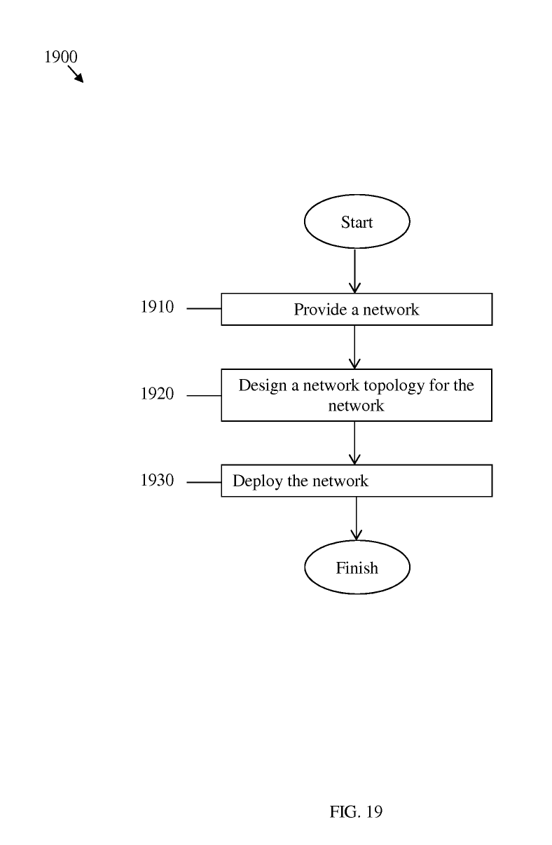

FIG. 19 is a flowchart illustrating a method 1900 according to an embodiment of the disclosure. At step 1910, a network may be provided. The network may be any suitable interconnection network. At step 1920, a network topology may be designed for the network. The network topology may be any of the disclosed network topologies or any other network topology designed according to the disclosed techniques. For example, the network topology may comprise a recursive, all-to-all network comprising N^{K} nodes, N^{K-1} clusters of nodes, and N available ports. Furthermore, the nodes and clusters may be connected using the disclosed algorithms. At step 1930, the network may be deployed. For example, the network may be deployed on an SoC or other suitable interconnection network. The network may thereafter be maintained so that it perpetuates the recursive, all-to-all design, or the network may be non-uniform. Furthermore, the network may be deployed onto existing networks, in addition to existing networks, in place of existing networks, or in any other suitable manner.

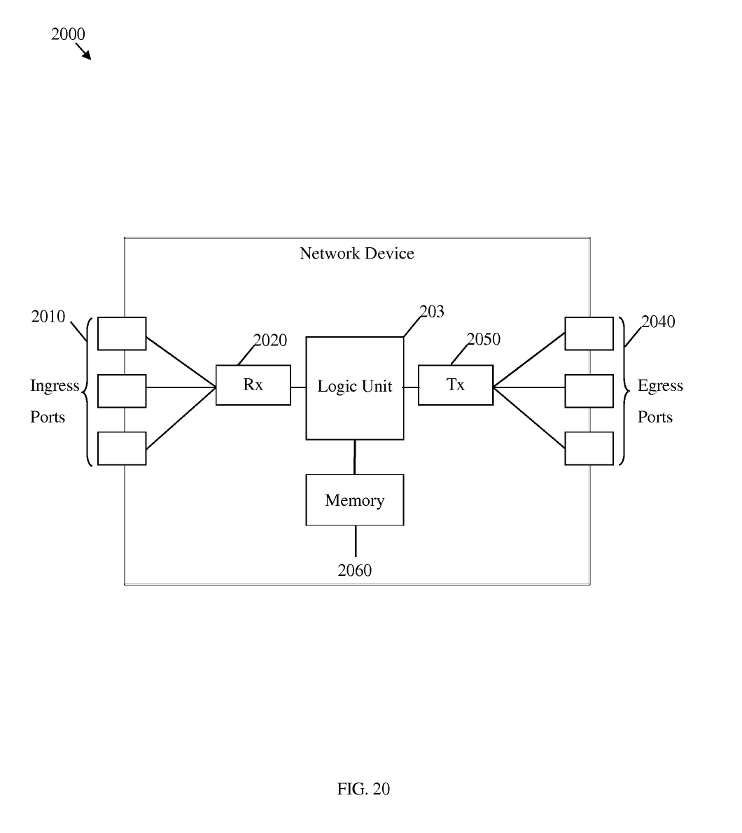

FIG. 20 is a schematic diagram of a network device 2000 according to an embodiment of the disclosure. The device 2000 may comprise a plurality of ingress ports 2010 and/or receiver units (Rx) 2020 for receiving data, a logic unit or processor 2030 to process signals, a plurality of egress ports 2040 and/or transmitter units (Tx) 2050 for transmitting data to other components, and a memory 2060. The device 2000 may be suitable for implementing any of the disclosed features, methods, and devices.

The logic unit 2030, which may be referred to as a central processing unit (CPU), may be in communication with the ingress ports 2010, receiver units 2020, egress ports 2040, transmitter units 2050, and memory 2060. The logic unit 2030 may be implemented as one or more CPU chips, cores (e.g., as a multi-core processor), field-programmable gate arrays (FPGAs), application specific integrated circuits (ASICs), and/or digital signal processors (DSPs), and/or may be part of one or more ASICs.

The memory 2060 may be comprised of one or more disks, tape drives, optical disc drives, or solid-state drives; may be used for non-volatile storage of data and as an over-flow data storage device; may be used to store programs when such programs are selected for execution; and may be used to store instructions and perhaps data that are read during program execution. The memory 2060 may be volatile and/or non-volatile and may be read-only memory (ROM), random-access memory (RAM), ternary content-addressable memory (TCAM), static random-access memory (SRAM), another suitable type of memory, or any combination thereof.

The device 2000 may represent any of the nodes described above. In each configuration, the nodes may reside on separate devices, on a single device as an SoC, or in any combination of devices forming an interconnection network suitable for implementing any of the disclosed features, methods, and devices. In other words, the disclosed technique is not limited to any specific hardware or software configuration.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k * (Rᵤ−R₁), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means +/−10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. An interconnection network comprising:
N^{K} nodes, wherein N is an integer of two or greater and represents a degree of the network, wherein each node comprises N ports, wherein K is an integer of one or greater and represents a recursion level of the network, and wherein N ports are left available for recursion; and
N^{K-1} clusters of nodes, wherein each cluster comprises N nodes, wherein each node within each cluster is directly connected to each remaining node in the cluster, and wherein each cluster is directly connected to at least one remaining cluster.

2. The network of claim 1, wherein i is a set of integers from one to N and represents a port number associated with each node, wherein j is a set of integers from one to N and represents a node number associated with each cluster, wherein each ith port of each jth node is directly connected to each jth port of each ith node, and wherein each port where i and j are a same number is left available for recursion.

3. The network of claim 2, wherein k is a set of integers from one to N^{K-1} and represents a cluster number; wherein each jth node of each kth cluster is directly connected to each kth node of each jth cluster; and wherein each port where i, j, and k are a same number is left available for recursion.

4. The network of claim 1, wherein K is equal to two, and wherein each cluster is directly connected to each remaining cluster.

5. The network of claim 1, further comprising N ports left available for recursion.

6. The network of claim 1, wherein the nodes are in a plurality of chips.

7. The network of claim 1, wherein the network is grown recursively for each K greater than one.

8. The network of claim 1, wherein the nodes are part of a first set of nodes, wherein the network comprises a second set of nodes identical to the first set of nodes, wherein the first set of nodes is directly connected to the second set of nodes, and wherein no ports are left available for recursion.

9. An interconnection network comprising:
a plurality of inter-cluster links;
a plurality of intra-cluster links; and
a plurality of clusters, wherein each cluster is directly connected via an inter-cluster link to at least one other cluster, wherein each cluster comprises N nodes where N is an integer of two or greater, wherein each node comprises N ports, wherein each node is directly connected via an intra-cluster link to each remaining node in a same cluster, and wherein N inter-cluster links are left available for recursion.

10. The network of claim 9, wherein i is a set of integers from one to N and represents a port number associated with each node, wherein j is a set of integers from one to N and represents a node number associated with each cluster, wherein each ith port of each jth node is directly connected via an intra-cluster link to each jth port of each ith node, and wherein each port where i and j are a same number comprises an inter-cluster link left available for recursion.

11. The network of claim 10, wherein k is a set of integers from one to N^{K-1} and represents a cluster number; wherein each jth node of each kth cluster is directly connected to each kth node of each jth cluster; and wherein each port where i, j, and k are a same number is left available for recursion.

12. The network of claim 9, wherein each port comprises a link.

13. The network of claim 9, wherein the nodes are in a system on a chip (SoC).

14. The network of claim 9, wherein the nodes are part of a first set of nodes, wherein the network comprises a second set of nodes identical to the first set of nodes, wherein the first set of nodes is directly connected to the second set of nodes, and wherein no ports are left available for recursion.

15. An interconnection network comprising:
a plurality of inter-cluster links;
a plurality of intra-cluster links; and
a plurality of clusters, wherein each cluster is directly connected via an inter-cluster link to at least one remaining cluster, wherein each cluster within a first set of clusters comprises N nodes where N is an integer of two or greater, wherein each node within the first set of clusters comprises N ports, wherein each node in the first set of clusters is directly connected via an intra-cluster link to each remaining node in a same cluster, wherein each remaining cluster is part of a second set of clusters, wherein at least one non-uniform node within the second set of clusters comprises M ports where M is an integer of two or greater and is not equal to N, wherein each node in the second set of clusters is directly connected via an intra-cluster link to at least one remaining node in a same cluster, and wherein at least one inter-cluster link is left available for recursion.

16. The network of claim 15, wherein when M is less than N, each cluster with a non-uniform node comprises no inter-cluster links left available for recursion; and wherein, when M is greater than N, each cluster with a non-uniform node comprises M−N inter-cluster links left available for recursion.

17. An interconnection network comprising:
a plurality of inter-cluster links;
a plurality of intra-cluster links; and
a plurality of clusters, wherein each cluster is directly connected via an inter-cluster link to at least one remaining cluster, wherein each cluster within a first set of clusters comprises N nodes where N is an integer of two or greater, wherein each node within the first set of clusters comprises N ports, wherein each node in the first set of clusters is directly connected via an intra-cluster link to each remaining node in a same cluster, wherein each remaining cluster is part of a second set of clusters, wherein at least one non-uniform cluster in the second set of clusters comprises L nodes where L is an integer of two or greater and is not equal to N, wherein each node in the second set of clusters is directly connected via an intra-cluster link to at least one remaining node in a same cluster, and wherein at least one inter-cluster link is left available for recursion.

18. The network of claim 17, wherein when L is less than N, each non-uniform cluster comprises no inter-cluster links left available for recursion; and wherein, when L is greater than N, each non-uniform cluster comprises L−N inter-cluster links left available for recursion.

19. A method comprising:
providing a network;
designing a network topology for the network, wherein the topology comprises N^{K} nodes and N^{K-1} clusters of nodes, wherein N is an integer of two or greater and represents a degree of the network, wherein each node comprises N ports, wherein K is an integer of one or greater and represents a recursion level of the network, wherein N ports are left available for recursion, wherein each cluster comprises N nodes, wherein each node within each cluster is directly connected to each remaining node in the cluster, and wherein each cluster is directly connected to at least one remaining cluster; and
deploying the network.

20. The method of claim 19, wherein i is a set of integers from one to N and represents a port number associated with each node; wherein j is a set of integers from one to N and represents a node number associated with each cluster; wherein each ith port of each jth node is directly connected to each jth port of each ith node; wherein each port where i and j are a same number is left available for recursion; wherein k is a set of integers from one to N^{K-1} and represents a cluster number; wherein each jth node of each kth cluster is directly connected to each kth node of each jth cluster; and wherein each port where i, j, and k are a same number is left available for recursion.
